(19) United States
(12) Patent Application Publication
(10) Pub. No.: US 2013/0244215 A1
(43) Pub. Date: Sep. 19, 2013

(54) OPERATING DEVICE AND GUIDING LEARNING METHOD FOR EARLY EDUCATION

(71) Applicant: Chee Chang HO, Shenzhen (CN)

(72) Inventor: Chee Chang HO, Shenzhen (CN)

(73) Assignee: D-RED TECHNOLOGIES LIMITED, Shenzhen (CN)

(21) Appl. No.: 13/617,479

(22) Filed: Sep. 14, 2012

(30) Foreign Application Priority Data
Mar. 19, 2012 (CN) 201220103927.4

(51) Int. Cl. G09B 5/00

(52) U.S. Cl. 434/322

(57) ABSTRACT

An operating device for early education is provided. The operating device includes an operating console comprising a plurality of various keyboards around an edge of the operating console used for receiving keystrokes, a data transceiver used for transmitting encoding information corresponding to keystrokes to a portable device and receiving activation controlling information from the portable device used for activating a keyboard, and a plurality of controlling keys used for receiving selection controlling information and transmitting the selection controlling information to the portable device by the data transceiver. Advantageously, the operating device includes a plurality of various keyboards that is independent of the portable device, which is convenient for children's operation/input. Additionally, a plurality of various keyboards are provided, advantageously, more learning content interacted by means of the various keyboards can be provided by the application programs via the portable devices.

### BACKGROUND OF THE INVENTION

1. Technical Field

The present invention relates to an electronic product for early education, and more particularly, to an operating device and a guiding learning method for early education.

2. Description of Related Art

A learning machine for early education is an educational electronic product specially used for children's early education. The children before age of five learn mostly by means of sensory organs. At present, electronic products for the early education from markets mainly includes learning machines and point of time machines, however, the electronic products are lack of contents which also are relatively constant. In another aspect, the electronic products only have a simple keyboard integrated with a display device for children to operation/input, such as an alphabetical keyboard (from A to Z) and a numeral keyboard (from 0 to 9) that can't be used for different application programs, which is inconvenient for children to operate and is lacking in interest.

### BRIEF SUMMARY OF THE INVENTION

A technical problem to be solved by the present invention is to overcome the shortcomings of the prior art.

In a first aspect of the invention, there is provided an operating device for early education includes an operating console, the operating console including:

a plurality of various keyboards around an edge of the operating console used for receiving keystrokes;

a data transceiver used for transmitting encoding information corresponding to the keystrokes to a portable device and receiving activation controlling information from the portable device used for activating a keyboard; and

a plurality of controlling keys used for receiving selection controlling information and transmitting the selection control information to the portable device by the data transceiver.

Furthermore, the operating console further includes:

a recess located in the middle of the plurality of various keyboards used for containing the portable device.

Particularly, the recess is formed by depressing the upper surface of the operating console.

Furthermore, the operating device further includes:

a supporting elements below the operating console used for supporting the operating console.

Preferably, the data transceiver is a data transceiver using Bluetooth protocols.

Preferably, the portable device is an iOS device, and the application program is an iOS App.

Preferably, the shape of the operating console substantially is triangle and the number of the keyboards is three.

Preferably, the shape of the operating console substantially is rectangle and the number of the keyboards is four.

Particularly, one of the plurality of various keyboards is an alphabetical keyboard, a numeral keyboard, a piano keyboard or a keyboard comprising a plurality of buttons with different shapes.

In a second aspect of the invention, there is provided a guiding learning method for early education, comprising:

starting an application program resided in a portable device;

activating a keyboard in the operating device corresponding to the application program, and displaying a learning content generated by the application program on the portable device;

receiving encoding information corresponding to keystrokes of the keyboard by the portable device, based on the encoding information, obtaining data information of the application program corresponding to the encoding information;

comparing the data information with the learning content and displaying relevant content based on the comparison,

wherein the operating device includes an operating console, and the operating console including:

a plurality of various keyboards around an edge of the operating console used for receiving keystrokes;

a data transceiver used for transmitting encoding information corresponding to keystrokes to a portable device; and

a plurality of controlling keys used for receiving selection controlling information and transmitting the selection controlling information to the portable device by the data transceiver.

Particularly, the step that starting an application program resided in a portable device includes:

receiving selection controlling information from one of the plurality of controlling keys via the data transceiver;

Starting an application program resided in a portable device based on the selection controlling information.

The present invention has the following benefits: the operating device includes a plurality of various keyboards that is independent of a portable device, which is convenient for children's operation/input. Additionally, a plurality of various keyboards provided, advantageously, more learning content interacted by means of the various keyboards can be provided by the application programs via the portable devices.

### BRIEF DESCRIPTION OF THE SEVERAL VIEWS OF THE DRAWINGS

FIG. 1 is a schematic structure view of an operating device for early education according to a first embodiment of the present invention;

FIG. 2 is a schematic structure view of an operating device for early education according to a second embodiment of the present invention;

FIG. 3 is a schematic structure view of an operating device for early education according to a third embodiment of the present invention; and

FIG. 4 is a flow chart of a guided learning method for early education according to the above-mentioned embodiments of the present invention.

### DETAILED DESCRIPTION OF THE INVENTION

In order to make clearer the objects, technical solutions and advantages of the invention, the present invention will be explained below in detail with reference to the accompanying drawings and embodiments.

In the present invention, the operating device includes an operating console, and the operating console may have any shape which children are interested in. The operating console includes a plurality of various keyboards around the surroundings of the operating console used for receiving keystrokes, a data transceiver used for transmitting encoding information corresponding to a user's/child's keystroke to a portable device and receiving activation controlling information from the portable device used for activating a keyboard, and a plurality of controlling keys used for receiving selection controlling information and transmitting the selection controlling information to the portable device by the data transceiver.

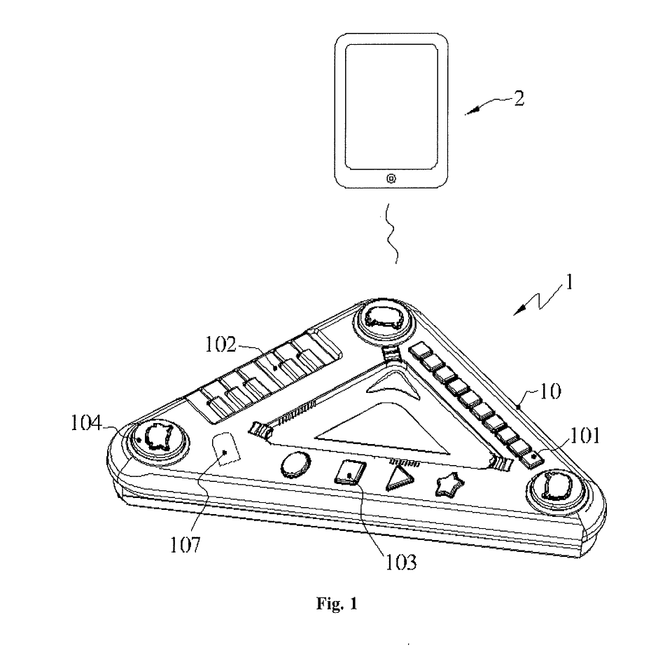

Referring to FIG. 1, exemplarily, FIG. 1 is a schematic structure view of an operating device for early education according to an embodiment of the present invention. The operating device 1 includes a operating console 10 whose shape substantially is a triangle, the operating console 10 includes three different keyboards 101, 102, 103 around the edge of the operating console 10 used for receiving a child's keystrokes, a data transceiver 107 used for transmitting encoding information corresponding to a child's keystrokes to a portable device 2 and receiving activation controlling information from the portable device 2 used for activating a keyboard, and a plurality of controlling keys 104 used for receiving child's selection controlling information and transmitting the selection controlling information to the portable device 2 by the data transceiver. In this embodiment, the data transceiver 107 may locate in an inside of the operating console 10. Preferably, the number of the controlling keys 104 is the same with that of the keyboards, each of the controlling keys is positioned between ends of two keyboards. Generally, the keyboards 101, 102, 103 are in off state, when an application program on the portable device 2 is selected, the selection controlling information is sent from the portable device 2 to the operating device 1 via the data transceiver 107 to activate a keyboard corresponding to the application program. Thus, other keyboards still are in off state, which reduces wrong inputs and the power consumption of the operating device 1.

Preferably, the data transceiver 107 is a data transceiver using Bluetooth protocols.

Preferably, the portable device is an iOS device, such as iPad, the application program is an iOS App.

As an example, there are three keyboards including a numeral keyboard 101, a piano keyboard 102 and a keyboard 103 having a plurality of keys with different shapes around the edge of the operating console 10. The numeral keyboard 101 is comprised of ten numeral keys, such as 0 to 9, which is used for guiding children to learn numbers. For example, when a child selects an application program having numeral learning content on the portable device 2, by pressing a controlling key 104 and transmitting the corresponding selection controlling information to the portable device 2 via the data transceiver 107, the numeral learning content is displayed on the portable device 2, thus the child is guided to press the corresponding numeral key. The piano keyboard 102 is comprised of black keys and white keys, which is used for guiding children to learn playing the piano. For example, when a child selects an application program used for learning playing the piano, by pressing a controlling key 104 and transmitting the corresponding selection controlling information to the portable device 2 via the data transceiver 107, a piano score and corresponding keystroke used for prompting the child are displayed on the portable device 2, thus the child is guided to press the corresponding piano key. It is to be noted that, in order to guide child to learn various knowledge, the keyboards are not limited in the mentioned keyboards, other keyboards can be included according to the application program on the portable device 2. Particularly, when application programs are displayed on the portable device 2, the positions of icons corresponding to the application programs are accordant with that of the controlling keys respectively, so that the selection of the application program can be simplified.

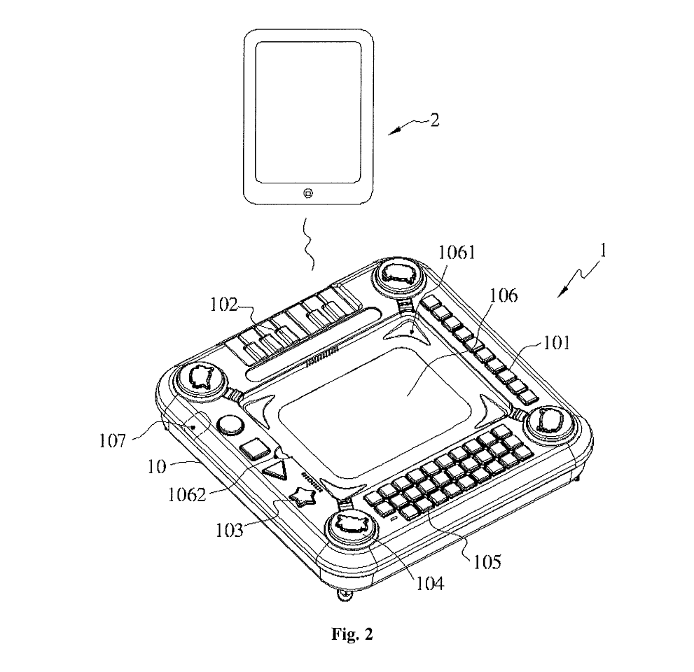

Referring to FIG. 2, exemplarily, FIG. 2 is a schematic structure view of an operating device for early education according to the second embodiment of the present invention. The operating device 1 includes a operating console 10 whose shape substantially is rectangle, the operating console 10 includes four different keyboards 101, 102, 103, 105 around the edge of the operating console 10 used for receiving a child's keystrokes, a data transceiver 107 used for transmitting encoding information corresponding to the child's keystrokes to a portable device 2, a plurality of controlling keys 104 used for receiving child's selection control information and transmitting the selection control information to the portable device 2 by the data transceiver 107. Furthermore, the operating console 10 further includes a recess 106 defined in the middle of the keyboards 101, 102, 103, 105 used for receiving the portable device 2. The shape and size of the recess 106 match with that of the portable device 2 respectively in order to receive the portable device 2. The recess 106 may be formed by depressing the upper surface of the operating console 10. Preferably, the bottom surface of the recess 106 may further include one or more through-holes 1061 used for the heat dissipation of the portable device 2. Preferably, the positions of the through-holes 1061 are accordant with that of air vents of the portable device 2, advantageously, the heat generated by the portable device 2 can be dissipated downwards via the through-holes 1061 and the comfort can be increased during operating the operating the console 1. Preferably, the edge of the recess 106 is provided with one or more finger holes 1062 used for easily accessing the portable device 2 by fingers. It is to be noted that the portable device 2 may be put in the recess 106, so that the child can watch the content displayed on the portable device 2, and the data transceiver 107 may locate in inside of the operating console 10. The portable device 2 also can be hold by other holding device independent of the operating device 10. In this embodiment, the portable device 2 is shown independent of the operating console 10.

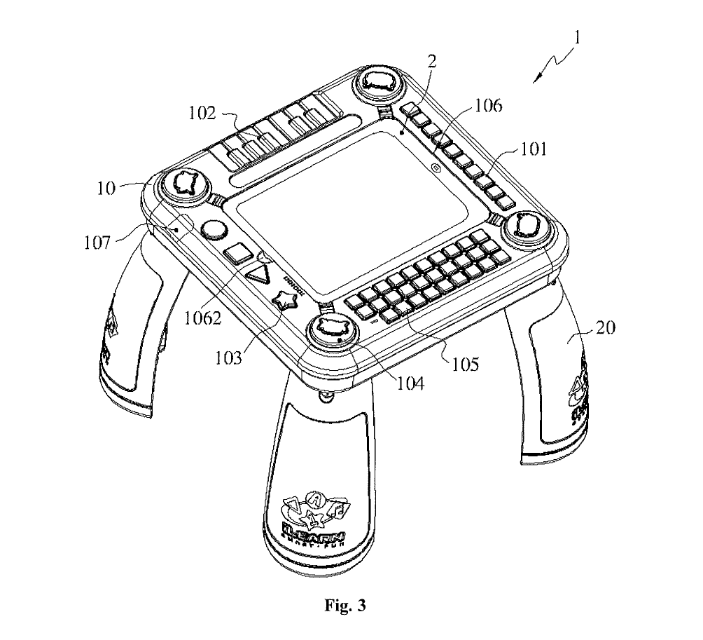

Referring to FIG. 3, exemplarily, FIG. 3 is a schematic structure view of an operating device for early education according to an embodiment of the present invention. The operating device 1 includes a operating console 10 whose shape substantially is rectangle, the operating console 10 includes four different keyboards 101, 102, 103, 105 around the edge of the operating console 10 used for receiving a child's keystrokes, a data transceiver 107 used for transmitting encoding information corresponding to the child's keystrokes to a portable device 2, a plurality of controlling keys 104 used for receiving the child's selection controlling information and transmitting the selection controlling information to the portable device 2 by the data transceiver 107 and a recess 106 located in the middle of the keyboards 101, 102, 103, 105 used for receiving the portable device 2. In this embodiment, the portable device 2 is received in the recess 106. One or more finger holes 1062 provided at the edge of the recess 106 may be used for conveniently taking the potable device 2 out from the recess 106 by fingers. Furthermore, the operating device 1 further includes four supporting elements 20 below the operating console used for supporting the operating console 10. In this embodiment, exemplarily, the operating device 1 is formed as a table, so that the supporting elements 20 may be four supporting legs used for supporting the operating console 10. Advantageously, children may move the operating device 1 easily, which increases the interest of the operation of the operating device 1.

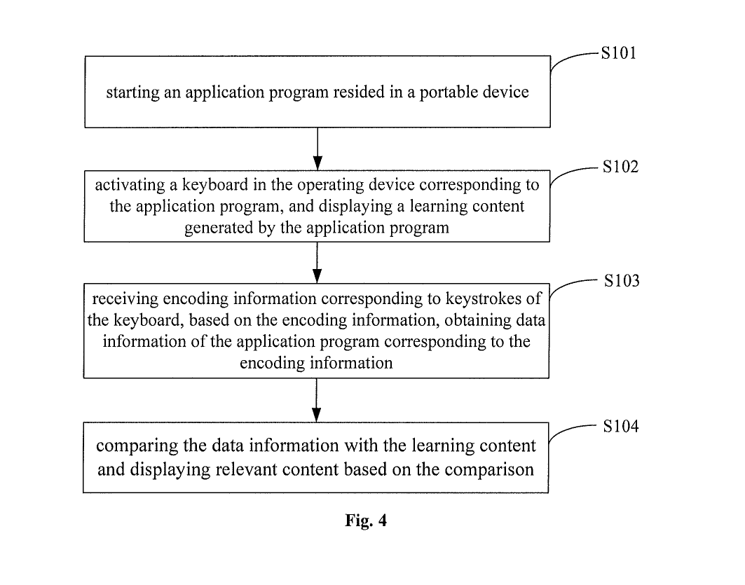

Referring to FIG. 4, FIG. 4 is a flow chart of a guiding learning method for early education based on the operating devices in the embodiments of FIG. 1, FIG. 2 or FIG. 3, the guiding learning method includes the following steps:

Step 101, starting an application program resided in a portable device.

In this embodiment of the present invention, the application program resided in the portable device may be selected directly on the portable device and then be started. Alternatively, the application program resided in the portable device may be selected by pressing a controlling key on the operating console corresponding to the application program displayed on the portable device. When the portable device receives a child's selection control information from the controlling key via the data transceiver, starts an application program resided in a portable device based on the selection controlling information. Preferably, the data transceiver is a data transceiver using Bluetooth protocols, the portable device is an iOS device, such as iPad, the application program is an iOS App.

Step 102, activating a keyboard in the operating device corresponding to the application program, and displaying a learning content generated by the application program on the portable device.

When an application program is selected, activation controlling information is sent from the portable device to the operating device via data transceiver. According to the activation controlling information a keyboard in the operating device corresponding to the application program is activated for receiving a child' keystrokes, and a learning content generated by the application program is displayed on the portable device. For example, if the learning content is numeral learning content, the numeral keyboard is activated to receive the child's keystroke of the numeral key. Thus other keyboards are in off state, which reduces wrong inputs.

Step 103, receiving encoding information corresponding to keystrokes of the keyboard by the portable device, based on the encoding information, obtaining data information corresponding to the encoding information according to the application program.

When the encoding information corresponding to keystrokes of the keyboard is received by the portable device, based on the encoding information, data information corresponding to the encoding information according to the application program is obtained.

Step 104, comparing the data information with the learning content and displaying relevant content based on the comparison.

In this embodiment, the data information is compared with the learning content, based on the comparison, the relevant content is displayed. As an example, if the data information is the same with the learning content, the next learning content is displayed, if not, the relevant message is displayed to prompt the child to press a right key. Thus children may be guided to input right content.

The present invention has been further detailed in the above descriptions with reference to the preferred embodiments; however, it shall not be construed that implementations of the present invention are only limited to these descriptions. Many simple deductions or replacements may further be made by those of ordinary skill in the art without departing from the conception of the present invention, and all of the deductions or replacements shall be considered to be covered within the protection scope of the present invention.

1. An operating device for early education comprising an operating console, the operating console comprising:
a plurality of various keyboards around an edge of the operating console used for receiving keystrokes;
a data transceiver used for transmitting encoding information corresponding to the keystrokes to a portable device and receiving activation controlling information from the portable device used for activating a keyboard; and
a plurality of controlling keys used for receiving selection controlling information and transmitting the selection controlling information to the portable device by the data transceiver.

2. The operating device of claim 1, wherein the operating console further comprises:
a recess located in the middle of the plurality of various keyboards used for containing the portable device.

3. The operating device of claim 2, wherein the recess is formed by depressing the upper surface of the operating console.

4. The operating device of claim 1, wherein the operating device further comprises:
a plurality of supporting elements below the operating console used for supporting the operating console.

5. The operating device of claim 1, wherein the data transceiver is a data transceiver using Bluetooth protocols.

6. The operating device of claim 1, wherein the portable device is an iOS device, and the application program is an iOS App.

7. The operating device of claim 1, wherein the shape of the operating console substantially is triangle and the number of the keyboards is three.

8. The operating device of claim 1, wherein the shape of the operating console substantially is rectangle and the number of the keyboards is four.

9. The operating device of claim 1, wherein one of the plurality of various keyboards is an alphabetical keyboard, a numeral keyboard, a piano keyboard or a keyboard comprising a plurality of buttons with different shapes.

10. A guiding learning method for early education, comprising:
starting an application program resided in a portable device;
activating a keyboard in the operating device corresponding to the application program, and displaying a learning content generated by the application program on the portable device;
receiving encoding information corresponding to keystrokes of the keyboard by the portable device, based on the encoding information, obtaining data information of the application program corresponding to the encoding information;
comparing the data information with the learning content and displaying relevant content based on the comparison,
wherein the operating device comprises an operating console, and the operating console comprising:
a plurality of various keyboards around an edge of the operating console used for receiving keystrokes;
a data transceiver used for transmitting encoding information corresponding to keystrokes to a portable device and receiving activation controlling information from the portable device used for activate a keyboard; and
a plurality of controlling keys used for receiving selection controlling information and transmitting the selection controlling information to the portable device by the data transceiver.

11. The guiding learning method of claim 10, wherein the step that starting an application program resided in a portable device comprises:
receiving selection controlling information from one of the plurality of controlling keys via the data transceiver;
Starting an application program resided in a portable device based on the selection controlling information.
